(19) United States
(12) Patent Application Publication
(10) Pub. No.: US 2006/0177223 A1
(43) Pub. Date: Aug. 10, 2006

(54) Wavelength division multiplexing-passive optical network

(75) Inventors: Seong-Taek Hwang, Pyeongtaek-si (KR); Kwan-Soo Lee, Seoul (KR); Chang-Sup Shim, Seoul (KR); Yun-Je Oh, Yongin-si (KR)

Correspondence Address: CHA & REITER, LLC, 210 ROUTE 4 EAST STE 103, PARAMUS, NJ, 07652, US

(73) Assignee: Samsung Electronics Co.; LTD.

(21) Appl. No.: 11/346,973

(22) Filed: Feb. 3, 2006

(30) Foreign Application Priority Data
Feb. 4, 2005 (KR) 2005-10838

(51) Int. Cl. H04J 14/00

(52) U.S. Cl. 398/71

(57) ABSTRACT

A passive optical network includes a central office generating multiplexed downstream optical signals, a plurality of subscriber units provided with the downstream optical signals of the corresponding wavelengths, and a remote node for relaying signals between the subscriber units and the central office. The central office comprises a broadband light source for generating a light of gain-clamped wide wavelength band with a gain channel and a plurality of incoherent channels; a plurality of downstream light sources for generating downstream optical signals the wavelengths of which are locked by the incoherent channels of the corresponding wavelengths; and a multiplexer/de-multiplexer for de-multiplexing the incoherent channels and outputting the de-multiplexed channels to the corresponding downstream light source and for multiplexing the upstream optical signals and outputting the multiplexed optical signals.

### CLAIM OF PRIORITY

This application claims priority to an application entitled “WAVELENGTH DIVISION MULTIPLEXING-PASSIVE OPTICAL NETWORK,” filed in the Korean Intellectual Property Office on Feb. 4, 2005 and assigned Serial No. 2005-10838, the contents of which are hereby incorporated by reference.

### BACKGROUND OF THE INVENTION

1. Field of the Invention

The present invention relates to an optical network, and more particularly to a wavelength division multiplexing-passive optical network (WDM-PON) utilizing optical signals generated by the locking wavelengths.

2. Description of the Related Art

In a wavelength division multiplexing-passive optical network (WDM-PON), an optical signal carrying data is transmitted through a corresponding channel having an intrinsic wavelength assigned to each of subscriber units. Accordingly, such a PON has a superior capability for maintaining the communication security as compared with other telecommunication networks. In addition, the PON can be easily expandable and adaptable for providing additional communication services required by each subscriber unit.

The WDM-PON can use a distributed feedback laser, a distributed feedback laser array, a multi-frequency laser, and a picosecond pulse light source, etc., as a light source for generating optical signals.

Recently, a spectrum-sliced light source having an excellent wavelength selecting property and which does not require a separate stabilizing means has been used to generate optical signals which are locked by incoherent lights. The spectrum-sliced light source is capable of easily managing the wavelength and the wavelength locking light source. A Febry-Perot laser and a reflective semiconductor amplifier, etc., may be used as the wavelength locking light source.

In addition, the passive optical network including a separate low speed communication circuit as a means for preventing data from being lost due to the generation of disorders has been suggested. Further, an annular network has been suggested as the passive optical network.

FIG. 1 illustrates the configuration of a conventional passive optical network having means for monitoring the network. As shown, the conventional passive optical network includes a central office 110, a remote node 130, and a plurality of subscriber units 140-1 to 140-n. The central office 110 and the remote node 130 are linked by a main optical fiber, and the remote node 130 and the subscriber units 140-1 to 140-1 are linked by branch optical fibers.

The central office 110 includes a plurality of downstream light transmitting and receiving modules 112-1 to 112-n, a multiplexer/de-multiplexer 111, a broadband light source 113 for generating the light of a broadband wave width, a circulator 114, and a monitoring means 120 for monitoring the state of the network.

Each of the downstream light transmitting and receiving modules 112-1 to 112-n can include a semiconductor light source for generating downstream optical signals, each having a locked wavelength, and a photodiode for detecting the upstream optical signals of the corresponding wavelengths, etc.

The multiplexer/de-multiplexer 111 de-multiplexes the multiplexed upstream optical signals and outputs the signals to the corresponding downstream transceivers 112-1 to 112-n, and also multiplexes the downstream optical signals and outputs the signals to the remote node 130 through the circulator 114. Further, the multiplexer/de-multiplexer 111 divides the light into incoherent channels having different wavelengths and outputs the divided light to the corresponding downstream transceivers 112-1 to 112-n.

The circulator 114 is located between the monitoring means 120 and the multiplexer/de-multiplexer 111 and is connected to the broadband light source 113. The circulator 114 outputs the light and the multiplexed upstream optical signals to the multiplexer/de-multiplexer 111, and outputs the multiplexed downstream optical signals to the remote node 130 through the monitoring means 120.

The monitoring means 120 includes a first wavelength selection engager 124 located between the circulator 114 and the remote node 130, a monitoring light source 121 for generating monitoring channels, and a monitoring channel detector 122 for detecting the monitoring channels.

The remote node 130 includes a multiplexer/de-multiplexer which de-multiplexes the multiplexed downstream optical signals and outputs the de-multiplexed signal to the corresponding subscriber units 140-1 to 140-n, and also multiplexes the upstream optical signals and outputs the multiplexed signals to the central office 110 and a band selection reflecting filter 132, which serves to reflect the monitoring channels outputted in the central office 110, to the central office 110.

However, the conventional optical network must include a separate broadcasting means, and the monitoring means is cumbersome in designing a passive optical network.

### SUMMARY OF THE INVENTION

Accordingly, the present invention has been made to solve the above-mentioned problems occurring in the prior art and provides additional advantages, by providing an economical passive optical network with a monitoring capability and capable of transmitting broadcasting optical signals without requiring a separate light source for generating the broadcasting optical signals.

In one embodiment, a passive optical network includes a central office generating multiplexed downstream optical signals, a plurality of subscriber units provided with the downstream optical signals of the corresponding wavelengths, and a remote node for relaying the subscriber units and the central office. The central office comprises: a broadband light source for generating a light of gain-clamped wide wavelength band comprising a gain channel and a plurality of incoherent channels; a plurality of downstream light sources for generating downstream optical signals the wavelengths of which are locked by the incoherent channels of the corresponding wavelengths; and a multiplexer/de-multiplexer for de-multiplexing the incoherent channels and outputting the de-multiplexed channels to the corresponding downstream light source and for multiplexing the upstream optical signals.

### BRIEF DESCRIPTION OF THE DRAWINGS

The above features and advantages of the present invention will be more apparent from the following detailed description taken in conjunction with the accompanying drawings, in which:

FIG. 1 is a view for showing the configuration of a conventional passive optical network;

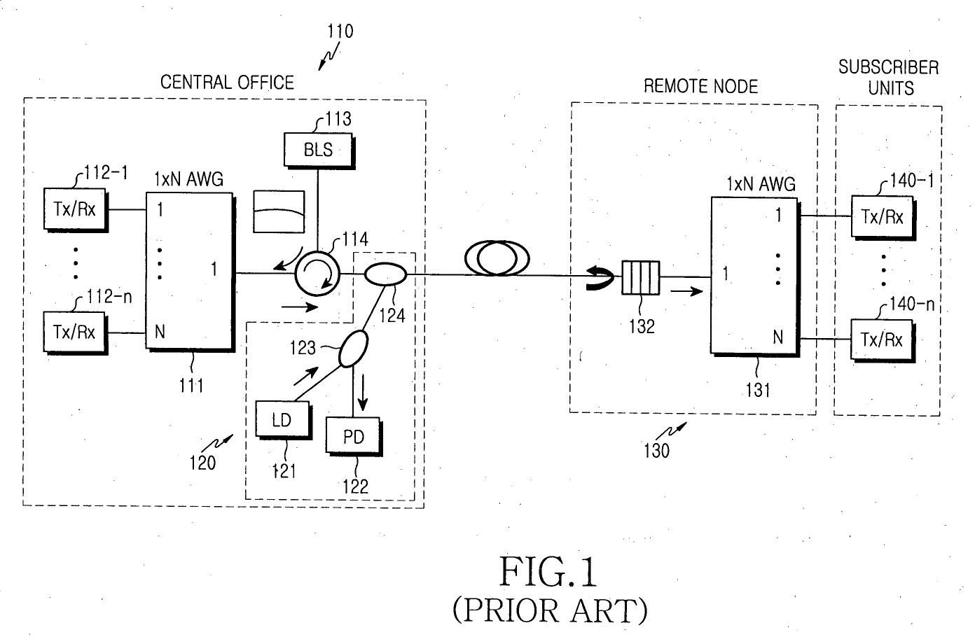

FIG. 2 is a view for showing the configuration of a passive optical network according to a first embodiment of the present invention;

FIG. 3 is a view for showing a partial configuration of a central office shown in FIG. 2;

FIG. 4 is a view for showing the configuration of a passive optical network according to a second embodiment of the present invention;

FIG. 5 is a view for showing the configuration of a passive optical network according to a third embodiment of the present invention; and

FIG. 6 is a view for showing the configuration of a passive optical network according to a fourth embodiment of the present invention;

### DETAILED DESCRIPTION

Hereinafter, embodiments of the present invention will be described with reference to the accompanying drawings. For the purposes of clarity and simplicity, a detailed description of known functions and configurations incorporated herein will be omitted as it may make the subject matter of the present invention unclear.

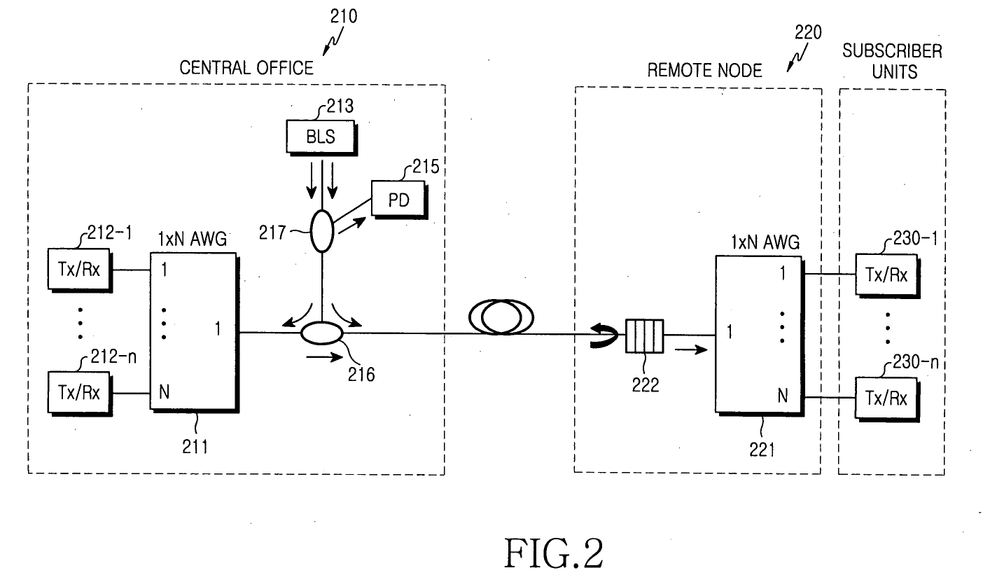

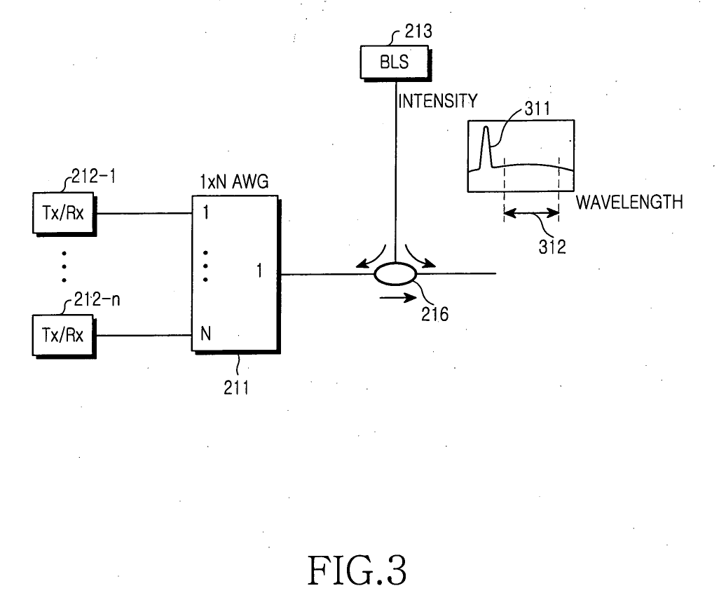

FIG. 2 illustrates the configuration of a passive optical network according to a first embodiment of the present invention. FIG. 3 is a view for showing a partial configuration of a central office shown in FIG. 2.

Referring to FIG. 2 and 3, a passive optical network according to the first embodiment of the present invention includes a central office 210 generating multiplexed downstream optical signals, a plurality of subscriber units 230-1 to 230-n provided with the downstream optical signals of the corresponding wavelengths, a remote node 220 for relaying signals between the subscriber units 230-1 to 230-n and the central office 210.

The central office 210 includes a broadband light source 213, a first multiplexer/de-multiplexer 211, a plurality of downstream optical transceivers 212-1 to 212-n, first and second wavelength selection engagers 216 and 217, and a monitoring optical detector 215.

The broadband light source 213 may include a gain-clamped semiconductor optical amplifier for generating a light of gain-clamped wide wavelength band having a plurality of incoherent channels and a gain channel, such that the gain channel 311 is separated from the wavelength bands of the incoherent channels 310, as shown in FIG. 3.

Each of the downstream optical transceivers 212-1 to 212-n generates a downstream optical signal wavelength of which are locked by the corresponding incoherent channel, and detects the upstream optical signal of the corresponding wavelength. Each of the downstream optical transceivers 212-1 to 212-n may include a semiconductor light source for generating the downstream optical signal and a photodiode for detecting the upstream optical signal of the corresponding wavelength. A Febry-Perot laser and a reflective semiconductor amplifier, etc. may be used as the semiconductor light source.

The first multiplexer/de-multiplexer 211 multiplexes the downstream optical signals and outputs the multiplexed signals to the remote node 220, and de-multiplexes the upstream optical signals multiplexed in the remote node 220 and outputs the de-multiplexed signal to the corresponding optical transceivers 212-1 to 212-n. Further, the first multiplexer/de-multiplexer 211 divides the incoherent channels and outputs divided channels to the corresponding downstream optical transceivers 212-1 to 212-n. The first multiplexer/de-multiplexer 211 may include an optical arrayed waveguide grating, a wavelength division multiplexing filter, or the like.

The first wavelength selection engager 216 outputs the gain channel of the light to the remote node 220, and divides the wavelength band of the light including the incoherent channels and outputs the divided light to the first multiplexer/de-multiplexer 211. Further, the remote node 220 outputs the reflected gain channel to the monitoring optical detector 215 through the second wavelength selection engager 217.

The second wavelength selection engager 217 outputs the gain channel inputted through the first wavelength selection engager 216 to the monitoring optical detector 215 and outputs the light inputted from the broadband light source 213 to the first wavelength selection engager 216.

The monitoring optical detector 215 detects the gain channel reflected in the remote node 220, and can determine the disorder states of the corresponding optical fibers or devices through detecting the gain channel. The monitoring optical detector 215 may use a photodiode etc.

The remote node 220 further includes a second multiplexer/de-multiplexer 221 and a band selection reflecting filter 222.

The second multiplexer/de-multiplexer 221 multiplexes the upstream optical signals generated by the subscriber units 230-1 to 230-n and outputs the multiplexed signals to the central office 210, and also de-multiplexes the downstream optical signals multiplexed in the central office 210 and outputs the de-multiplexed signal to the corresponding subscriber units 230-1 to 230-n.

The band selection reflecting filter 222 is located between the central office 210 and the second multiplexer/de-multiplexer 221, and reflects only the gain channel to the central office 210. Further, the band selection reflecting filter 222 outputs the upstream optical signals multiplexed in the second multiplexer/de-multiplexer 221 to the central office 210, and outputs the multiplexed downstream optical signals to the second multiplexer/de-multiplexer 221.

The band selection reflecting filter 222 may use filters of thin film in which a dielectric material is deposited so as to form a multi-layer. The band selection reflecting filter 222 can select a necessary wavelength band and reflect it or can transmit a predetermined wavelength band.

Each of the subscriber units 230-1 to 230-n may include a light source capable of generating an upstream optical signal and an upstream optical detector capable of detecting the downstream optical of the corresponding wavelength, and detects the downstream optical signal of the corresponding wavelength de-multiplexed in the remote node 220.

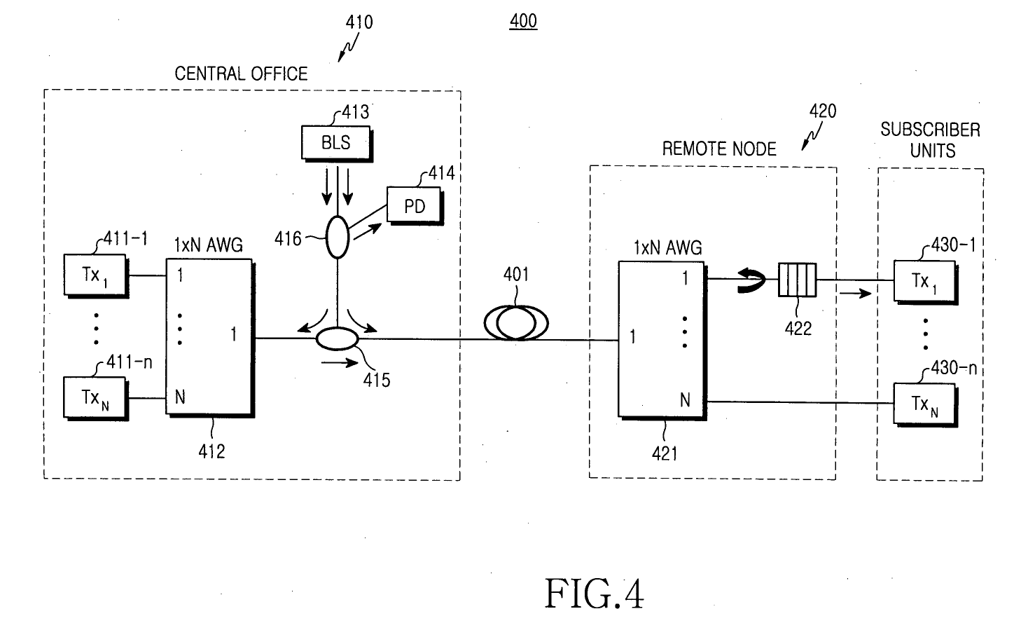

FIG. 4 illustrates the configuration of a passive optical network according to the second embodiment of the present invention.

As shown, the passive optical network according to the second embodiment of the present invention includes a central office 410 generating multiplexed downstream optical signals, a plurality of subscriber units 430-1 to 430-n provided with downstream optical signals of the corresponding wavelengths, and a remote node 420 for relaying signals between the subscriber units 430-1 to 430-n and the central office 420.

The central office 410 includes a broadband light source 413, a first multiplexer/de-multiplexer 412, a plurality of downstream light sources 411-1 to 411-n, and first and second wavelength selection engagers 415 and 416, and a monitoring optical detector 414.

The broadband light source 413 may include a gain-clamped semiconductor laser which can generate a light of gain-clamped wide wavelength band having a plurality of incoherent channels and gain channel. The gain channel is separated from the wavelength bands of the incoherent channels.

Each of the downstream optical light sources 411-1 to 411-n generates a downstream optical signal wavelength of which are locked by the corresponding incoherent channel, and each may include a Febry-Perot laser, a reflective semiconductor amplifier, or the like.

The first multiplexer/de-multiplexer 412 multiplexes the downstream optical signals and outputs the multiplexed optical signals to the remote node 220, and divides the incoherent channels of the light and outputs the divided channels to the downstream light source. The first multiplexer/de-multiplexer 412 may include an optical arrayed waveguide grating, a wavelength division multiplexing filter, or the like.

The first wavelength selection engager 415 outputs the gain channel among the light to the remote node 420, and divides the wavelength bands of the light including the incoherent channels and outputs the divided light to the first multiplexer/de-multiplexer 412. The second wavelength selection engager 416 outputs the gain channel inputted through the first wavelength selection engager 415 to the monitoring optical detector 414, and outputs the light inputted from the broadband light source 413 to the first wavelength selection engager 415. The monitoring optical detector 414 detects the gain channel reflected in the remote node 420.

The remote node 420 includes a second multiplexer/de-multiplexer 421 and a band selection reflecting filter 422. The second multiplexer/de-multiplexer 421 de-multiplexes the downstream optical signals multiplexed in the central office 410 and outputs the de-multiplexed signal to the corresponding subscriber units 430-1 to 430-n.

The band selection reflecting filter 422 reflects the gain channel to the central office 410 and located between the second multiplexer/de-multiplexer 421 and the corresponding subscriber units 430-1 to 430-n, and outputs the downstream optical signals of the corresponding wavelengths to the corresponding subscriber units 430-1 to 430-n.

Each of the subscriber units 430-1 to 430-n may include an upstream optical detector capable of detecting the downstream optical signals of the corresponding wavelengths.

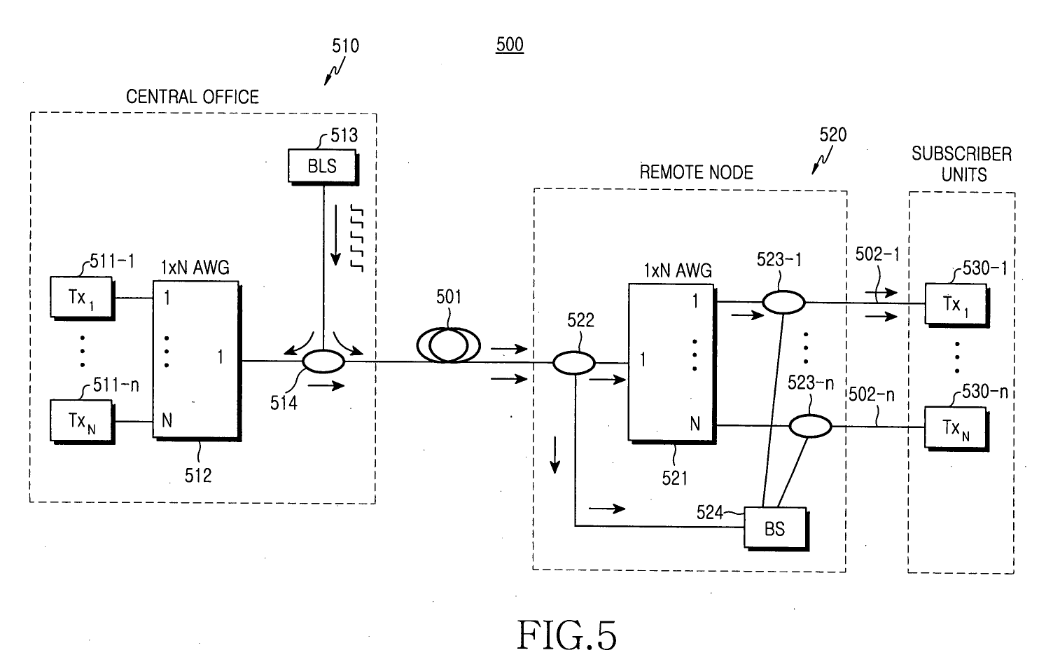

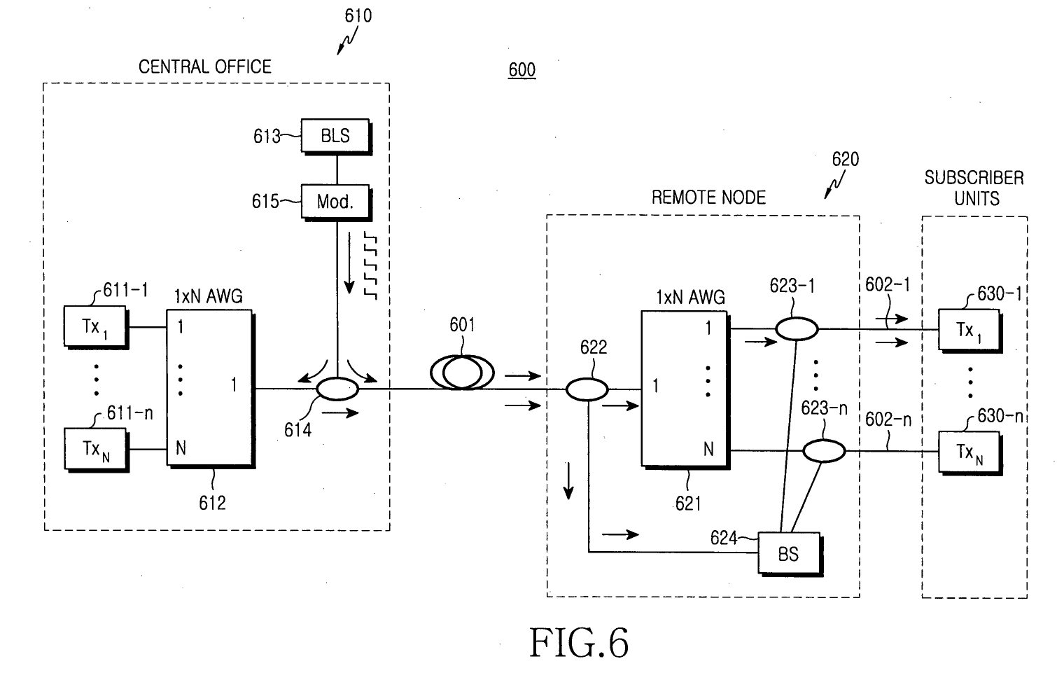

FIGS. 5 and 6 illustrate the configurations of passive optical network according to the third and fourth embodiments of the present invention which are capable of simultaneously transmitting multiplexed downstream optical signals and a broadcasting optical signal. In particular, FIG. 5 shows the configuration which does not have an exterior modulator for modulating a gain channel to a broadcasting optical signal, and FIG. 6 shows the configuration which further includes an exterior modulator for modulating a gain channel to a broadcasting optical signal.

Referring to FIG. 5, the passive optical network 500 according to the third embodiment includes a central office 510 for generating multiplexed downstream optical signals and a broadcasting optical signal, a plurality of subscriber units 530-1 to 530-n provided with the downstream optical signals of the corresponding wavelengths and the broadcasting optical signal, and a remote node 520 for relaying signals between the subscriber units 530-1 to 530-1 and the central office 510. The central office 510 and the remote node 520 are linked by a main optical fiber 501, and the remote node 520 and the subscriber units 530-1 to 530-n are linked by branch optical fibers 502-1 to 502-n.

The central office 510 includes a broadband light source 513 for generating the light of gain-clamped wide wavelength band, a plurality of downstream light sources 511-1 to 511-n for generating the downstream optical signals, a multiplexer 512, and a first wavelength selection engager 514.

The broadband light source 513 may include a gain-clamped semiconductor optical amplifier for generating a light of gain-clamped wide wavelength band comprising a gain channel and a plurality of incoherent channels. The wavelength intervals between the gain channel and the incoherent channels generated in the gain-clamped semiconductor optical amplifier may be controlled according to the needs of a user. The gain channel is modulated to a data containing broadcasting optical signal by the direct modulation of the broadband light source 513.

Each of the downstream light sources 511-1 to 511-n generates downstream optical signals the wavelengths of which are locked by the incoherent channel of the corresponding wavelength.

The multiplexer 512 divides the incoherent channels among the wavelength bands of the light and outputs the divided channels to the corresponding downstream light source, and multiplexes the wavelength locked downstream optical signals and outputs the multiplexed optical signals to the remote node 520.

The first wavelength selection engager 514 outputs the broadcasting optical signal and the multiplexed downstream optical signals to the remote node 520, and outputs the wavelength bands including the incoherent channels among the light to the multiplexer 512.

The remote node 520 includes a de-multiplexer 521, a beam splitter 524 for splitting the broadcasting optical signal, a second wavelength selection engager 522, and a plurality of third wavelength selection engagers 523-1 to 523-n.

The de-multiplexer 521 de-multiplexes the multiplexed downstream optical signals and outputs the de-multiplexed signal to the corresponding subscriber units 530-1 to 530-n through the third wavelength selection engagers 523-1 to 523-n. The de-multiplexer 521 may include an optical arrayed waveguide grating, etc.

The beam splitter 524 splits the broadcasting optical signal inputted from the central office 510 through the second wavelength selection engager 522 and outputs the split broadcasting optical signal to the subscriber units 530-1 to 530-n through the third wavelength selection engagers 523-1 to 523-n.

The second wavelength selection engager 522 is located between the central office 510 and the de-multiplexer 521, and outputs the multiplexed downstream optical signals to the de-multiplexer 521 and outputs the broadcasting optical signal to the beam splitter 524.

The third wavelength selection engagers 523-1 to 523-n are located between the de-multiplexer 521 and the corresponding subscriber units 530-1 to 530-n, and outputs the corresponding downstream optical signal and the split broadcasting optical signals to the corresponding subscriber units 530-1 to 530-n.

Referring to FIG. 6, the passive optical network 600 according to the fourth embodiment of the present invention includes a central office 610 for generating multiplexed downstream optical signals and a broadcasting signal, a plurality of subscriber units 630-1 to 630-n provided with the downstream optical signals of the corresponding wavelengths and the broadcasting optical signal, and a remote node 620 for relaying signals between the subscriber units 630-1 to 630-n and the central office 610. The central office 610 and the remote node 620 are linked by a main optical fiber 601, and the remote node 620 and the subscriber units 630-1 to 630-n are linked by branch optical fibers 602-1 to 602-n.

The central office 610 includes a broadband light source 613 for generating the light of gain-clamped wide wavelength band, a plurality of downstream light sources 611-1 to 611-n for generating the downstream optical signals, a multiplexer 612, a first wavelength selection engager 614, and an exterior modulator 615.

The broadband light source 613 may include a gain-clamped semiconductor optical amplifier for generating a light of gain-clamped wide wavelength band comprising a gain channel and a plurality of incoherent channels. The wavelength intervals between the gain channel and the incoherent channels generated in the gain-clamped semiconductor optical amplifier may be controlled according to the needs of a user.

The exterior modulator 615 modulates the gain channel to a broadcasting optical signal containing broadcasting data, and outputs the signal to the remote node through the first wavelength selection engager 614.

The remote node 620 includes a de-multiplexer 621, a beam splitter 624 for splitting the broadcasting optical signal, a second wavelength selection engager 622, and a plurality of third wavelength selection engagers 623-1 to 623-n. The remote node 620 de-multiplexes the multiplexed downstream optical signals inputted from the central office 610 and outputs the de-multiplexed signal to the corresponding to the subscriber units 630-1 to 630-n, and splits the broadcasting optical signal and outputs split broad optical signal to the subscriber units 630-1 to 630-n.

Each of the subscriber units 630-1 to 630-n may include a photodiode etc., as an optical detector for detecting the downstream optical signal of the corresponding wavelength and the broadcasting optical signal.

The passive optical network according to the present invention has an advantage in that it can generate a monitoring channel for monitoring a network without including a separate light source by using a gain-clamped semiconductor optical amplifier. The network, as shown in FIGS. 2 and 4, is monitored using a light of gain-clamped wide wavelength band having a gain channel and a plurality of incoherent channels, and data and broadcasting optical signals are transmitted as shown in FIGS. 5 and 6. Also, the present invention can exclude a separate configuration for generating the broadcasting optical signal, thus reducing the installation cost to yield an economical passive optical network.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A passive optical network comprising:
a central office for generating multiplexed downstream optical signals, the central office including: a broadband light source for generating a light of gain-clamped wide wavelength band having a gain channel and a plurality of incoherent channels; a plurality of downstream light sources for generating downstream optical signals locked by the incoherent channels of the corresponding wavelengths; and a multiplexer/de-multiplexer for de-multiplexing the incoherent channels and outputting the de-multiplexed channels to the corresponding downstream light source and for multiplexing upstream optical signals;
a plurality of subscriber units for processing the downstream optical signals of corresponding wavelengths; and
a remote node for relaying signals between the subscriber units and the central office.

2. A passive optical network according to claim 1, wherein the remote note further comprising a band selection reflecting filter for reflecting the generated light of the gain channel back to the central office.

3. A passive optical network according to claim 2, wherein the central office comprising a monitoring optical detector for detecting the light of the gain channel reflected in the remote node.

4. A passive optical network comprising:
a central office having a broadband light source for generating a light of gain-clamped wide wavelength band with a gain channel and a plurality of incoherent channels and for generating downstream optical signals locked by the incoherent channels of the corresponding wavelengths;
a plurality of subscriber units for processing the downstream optical signals of the corresponding wavelengths and generating upstream optical signals; and
a remote node for multiplexing the upstream optical signals and outputting the multiplexed upstream optical signals to the central office, for outputting the downstream optical signals to the corresponding subscriber units, and for reflecting the gain channel to the central office.

5. A passive optical network according to claim 4, wherein the central office comprises:
a plurality of downstream optical transceivers for generating the downstream optical signals and detecting the upstream optical signals of the corresponding wavelengths;
a first multiplexer/de-multiplexer for multiplexing the downstream optical signals and for de-multiplexing the multiplexed upstream optical signals and outputting the de-multiplexed upstream optical signals to the corresponding downstream optical transceivers;
a first wavelength selection engager for outputting the gain-clamped wide wavelength band including the gain channel among the light to the remote node and for outputting the gain-clamped wide wavelength band having the incoherent channels to the first multiplexer/de-multiplexer;
a monitoring optical detector for detecting the gain channel reflected in the remote node; and
a second wavelength selection engager for outputting the gain channel received through the first wavelength selection engager to the monitoring optical detector and for outputting the light received from the wide band light source to the first wavelength selection engager.

6. A passive optical network according to claim 4, wherein the remote node comprises:
a second multiplexer/de-multiplexer for multiplexing the upstream optical signals and for de-multiplexing the downstream optical signals multiplexed in the central office; and
a band selection reflecting filter disposed between the central office and the second multiplexer/de-multiplexer for reflecting only the gain channel to the central office.

7. A passive optical network according to claim 4, wherein the remote node comprises:
a second multiplexer/de-multiplexer for multiplexing the upstream optical signals, de-multiplexing the multiplexed downstream optical signals, outputting the de-multiplexed downstream optical signals to the corresponding subscribers, and for splitting and outputting the gain channel; and
a band selection reflecting filter disposed between the corresponding subscriber units and the second multiplexer/de-multiplexer for reflecting only the gain channel to the central office.

8. A passive optical network comprising:
a central office having a broadband light source for generating a light of gain-clamped wide wavelength band with a gain channel and a plurality of incoherent channels and a plurality of downstream light sources for generating downstream optical signals locked by the incoherent channels of the corresponding wavelengths, for modulating the gain channel to a broadcasting optical signals;
a plurality of subscriber units for processing the downstream optical signals of the corresponding wavelengths; and
a remote node for outputting the downstream optical signals to the corresponding subscriber units, and for splitting the broadcasting optical signals and outputting the split broadcasting optical signals to the subscriber units.

9. A passive optical network according to claim 8, wherein the broadband light source comprises a gain-clamped semiconductor optical amplifier for modulating the gain channel to broadcasting optical signals and outputting the signal.

10. A passive optical network according to claim 8, wherein the central office comprises:
a multiplexer for outputting the incoherent channels to the corresponding downstream light sources and for multiplexing the downstream optical signals generated in the downstream light sources and outputting the multiplexed downstream optical signals to the remote node; and
a first wavelength selection engager for outputting the broadcasting optical signals and the multiplexed downstream optical signals to the remote node, and for outputting the incoherent channels to the multiplexer.

11. A passive optical network according to claim 8, wherein each of the downstream light sources comprises a Febry-Perot laser.

12. A passive optical network according to claim 8, wherein each of the down link light sources comprises a reflective semiconductor optical amplifier.

13. A passive optical network according to claim 8, wherein the central office further comprises:
a multiplexer for outputting the incoherent channels to the corresponding downstream light sources and for multiplexing the downstream optical signals generated in the downstream light sources and outputting the multiplexed downstream optical signals to the remote node;
a first wavelength selection engager for outputting the broadcasting optical signals and the multiplexed downstream optical signals to the remote node and for outputting the incoherent channels to the multiplexer; and
an exterior modulator, disposed between the broadband light source and the first wavelength selection engager, for generating the broadcasting optical signals to which broadcasting data are modulation in the gain channel.

14. A passive optical network according to claim 8, wherein the remote node comprises:
a de-multiplexer for de-multiplexing the multiplexed downstream optical signals and outputting the de-multiplexed downstream optical signals to the corresponding subscriber units;
a beam splitter for splitting the broadcasting optical signals and outputting the split broadcasting optical signals to the subscriber units;
a second wavelength selection engager, disposed between the central office and the de-multiplexer, for outputting the multiplexed downstream optical signals to the de-multiplexer and for outputting the broadcasting optical signals to the beam splitter; and
a plurality of third wavelength selection engagers, located between the de-multiplexer and the subscriber units, for outputting the de-multiplexed downstream optical signals and the split broadcasting optical signals.
